(19) United States
(12) Patent Application Publication
(10) Pub. No.: US 2024/0393302 A1
(43) Pub. Date: Nov. 28, 2024

(54) MODEL FUNCTION FITTING DEVICE AND MODEL FUNCTION FITTING METHOD

(71) Applicant: Shimadzu Corporation, Kyoto-shi (JP)

(72) Inventor: Akira NODA, Kyoto-shi (JP)

(21) Appl. No.: 18/570,400

(22) PCT Filed: Jun. 17, 2022
(86) PCT No.: PCT/JP2022/024399

§ 371 Date: Jun. 26, 2024

(30) Foreign Application Priority Data
Jun. 18, 2021 (JP) 2021-101606

(51) Int. Cl. G01N 30/86; G06F 17/10

(52) U.S. Cl. CPC G01N 30/8693; G06F 17/10

(57) ABSTRACT

A model function fitting device includes an acquirer that acquires a chromatogram, and a fitter that fits a model function to the chromatogram, while applying, to the model function, a constraint that the model function described by a logarithmic scale has a first portion being approximatable to a quadratic function and second portions being located at both sides of the first portion and being approximatable to a linear function.

### TECHNICAL FIELD

The present invention relates to a model function fitting device and a model function fitting method for fitting a model function to a chromatogram.

### BACKGROUND ART

Various model functions shown in Non-Patent Document 1 are suggested for a quantitative analysis and a qualitative analysis of a waveform measured by a chromatograph. In regard to application to a peak separation algorithm, a model function is required to be able to fit a measured waveform with high accuracy and is required to be less likely to take a shape different from a peak waveform of a chromatogram with respect to any parameter. In order to meet these requirements, an EMG function and a BEMG function described in Non-Patent Document 2, for example, are used.
[Non-Patent Document 1] “Peakfit,” HULINKS Inc., [Search on Jun. 4, 2021], <URL: https://www.hulinks.co.jp/software/da_visual/peakfit/functions #chorom>
   [Non-Patent Document 2] “New Data Processing Method for Photodiode Array Detectors,” SHIMADZU CORPORATION, [Search on Jun. 4, 2021], <URL: https://www.shimadzu.com/an/sites/shimadzu.com.an/files/pim/pim_document_file/te chnical/technical_reports/13438/jpl217011.pdf>

### SUMMARY OF INVENTION

### Technical Problem

By using the EMG function or the BEMG function, it is possible to separate peaks from many measured waveforms. However, if there is a model function with which fitting can be performed with higher accuracy, it is highly convenient for a user.

An object of the present invention is to provide a model function with which fitting can be performed with high accuracy.

### Solution to Problem

A model function fitting device according to one aspect of the present invention includes an acquirer that acquires a chromatogram, and a fitter that fits a model function to the chromatogram, while applying, to the model function, a constraint that the model function described by a logarithmic scale has a first portion being approximatable to a quadratic function and second portions being located at both sides of the first portion and being approximatable to a linear function.

### Advantageous Effects of Invention

With the present invention, it is possible to provide a model function with which fitting can be performed with high accuracy.

### BRIEF DESCRIPTION OF THE DRAWINGS

FIG. 1 is a diagram showing the configuration of a model function fitting device according to the present embodiment.

FIG. 2 is a block diagram showing the functions of the model function fitting device according to the present embodiment.

FIG. 3 is a diagram showing a chromatogram.

FIG. 4 is a diagram showing a logarithm of the chromatogram.

FIG. 5 is a diagram showing fitting of a Generalized Additive Model to a chromatogram.

FIG. 6 is a diagram showing the residual calculated by simulation of model function fitting according to a first embodiment.

FIG. 7 is a diagram showing the residual calculated by simulation of BEMG function fitting.

FIG. 8 is a diagram for comparing a model function according to the first embodiment and a model function fitted with a unimodal restriction.

FIG. 9 is a diagram showing a model function fitted to simulation data.

FIG. 10 is a diagram for comparing a result of simulation with a model function according to a second embodiment and a result of simulation with a BEMG function to each other.

FIG. 11 is a diagram for comparing a result of simulation with the model function according to the second embodiment, a result of simulation with an EMG function and a result of simulation with the BEMG function to one another.

FIG. 12 is a diagram showing a chromatogram C2 of a sample to be analyzed in a third embodiment.

FIG. 13 is a diagram showing a logarithm LC2 of a chromatogram C2.

FIG. 14 is a diagram showing a chromatogram C3 that is converted using a conversion function.

FIG. 15 is a diagram showing a logarithm LC3 of a chromatogram C3.

FIG. 16 is a diagram showing a chromatogram C5 that is converted using a conversion function.

FIG. 17 is a diagram showing a logarithm LC5 of the chromatogram C5.

FIG. 18 is a diagram showing a chromatogram C7 that is converted using a conversion function.

FIG. 19 is a diagram showing a logarithm LC7 of the chromatogram C7.

FIG. 20 is a diagram showing a logarithmic chromatogram LC9.

FIG. 21 is a diagram showing a spline group used with a GAM.

FIG. 22 is a diagram showing the GAM model applied to the logarithmic chromatogram LC9.

FIG. 23 is a diagram showing the GAM model applied to a time distortion function.

FIG. 24 is a diagram showing vibration of coefficient caused by fitting.

FIG. 25 is a flowchart showing a model function fitting method according to an embodiment.

FIG. 26 is a flowchart showing the model function fitting method according to the embodiment.

### DESCRIPTION OF EMBODIMENTS

A model function fitting device and a model function fitting method according to embodiments of the present invention will now be described with reference to the attached drawings.

### (1) Configuration of Model Function Fitting Device

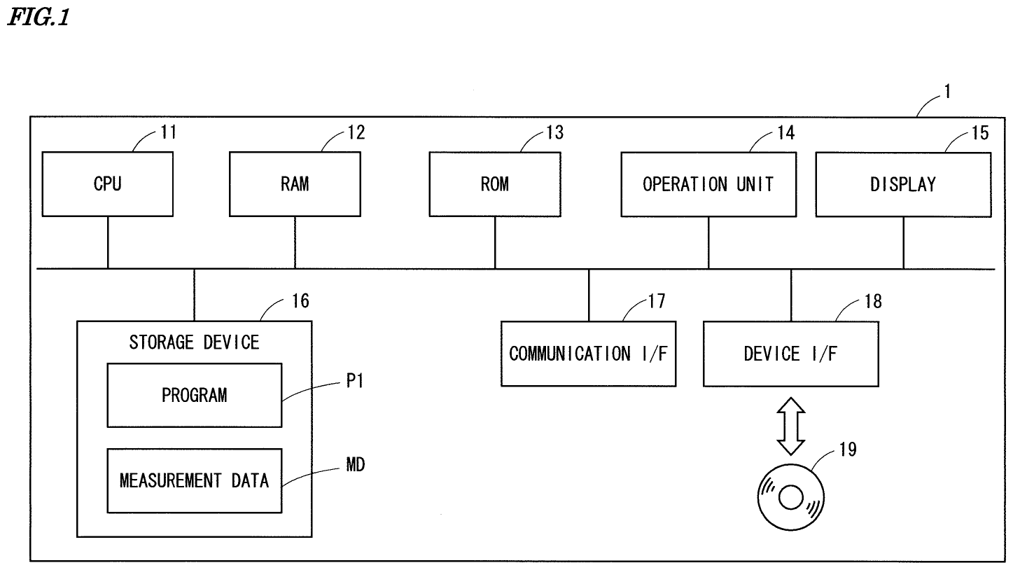

FIG. 1 is a diagram showing the configuration of the model function fitting device 1 according to an embodiment. The model function fitting device 1 of the present embodiment acquires measurement data MD of a sample obtained in a liquid chromatograph, a gas chromatograph or the like.

The model function fitting device 1 of the present embodiment is constituted by a personal computer. As shown in FIG. 1, the model function fitting device 1 includes a Central Processing Unit (CPU) 11, a Random Access Memory (RAM) 12, a Read Only Memory (ROM) 13, an operation unit 14, a display 15, a storage device 16, a communication interface (I/F) 17 and a device interface (I/F) 18.

The CPU 11 controls the model function fitting device 1 as a whole. The RAM 12 is used as a work area for execution of a program by the CPU 11. Various data, a program and the like are stored in the ROM 13. The operation unit 14 receives an input operation performed by a user. The operation unit 14 includes a keyboard, a mouse, etc. The display 15 displays information such as a result of fitting. The storage device 16 is a storage medium such as a hard disc. A program P1 and the measurement data MD are stored in the storage device 16. The program P1 executes a process of acquiring a chromatogram and a process of fitting a model function to a chromatogram. The communication interface 17 is an interface that communicates with another computer through wireless or wired communication. The device interface 18 is an interface that accesses a storage medium 19 such as a CD, a DVD or a semiconductor memory.

### (2) Functional Configuration of Model Function Fitting Device

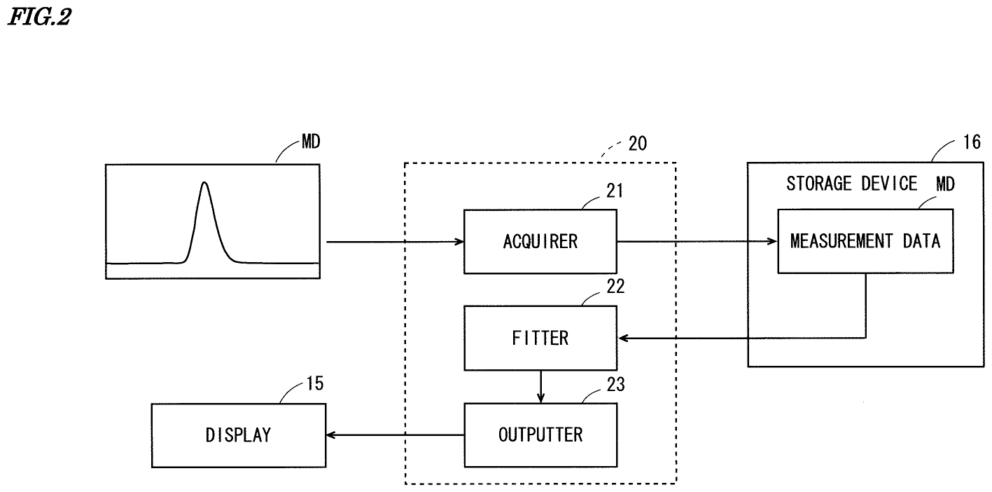

FIG. 2 is a block diagram showing the functional configuration of the model function fitting device 1. In FIG. 2, a controller 20 is a function that is implemented by execution of the program P1 by the CPU 11 while the CPU 11 uses the RAM 12 as a work area. The controller 20 includes an acquirer 21, a fitter 22 and an outputter 23. That is, the acquirer 21, the fitter 22 and the outputter 23 are the functions implemented by execution of the program P1. In other words, each of the functions 21 to 23 is a function included in the CPU 11.

The acquirer 21 receives the measurement data MD. The acquirer 21 receives the measurement data MD from another computer, an analysis device or the like via the communication interface 17, for example. Alternatively, the acquirer 21 receives the measurement data MD stored in the storage medium 19 via the device interface 18.

The fitter 22 executes the process of fitting a model function to a chromatogram. The fitter 22 of the present embodiment fits a model function to a chromatogram, while applying a constraint to the model function that the model function described by a logarithmic scale has a first portion being approximatable to a quadratic function and second portions being at both sides of the first portion and being approximatable to a linear function.

The outputter 24 causes the display 15 to display a result of fitting performed by the fitter 22 and information in regard to a fitted model function.

The program P1 is stored in the storage device 16, byway of example. In another embodiment, the program P1 may be provided in the form of being stored in the storage medium 19. The CPU 11 may access the storage medium 19 via the device interface 18 and may store the program P1 stored in the storage medium 19, in the storage device 16 or the ROM 13. Alternatively, the CPU 11 may access the storage medium 19 via the device interface 18 and may execute the program P1 stored in the storage medium 19.

### (3) First Embodiment

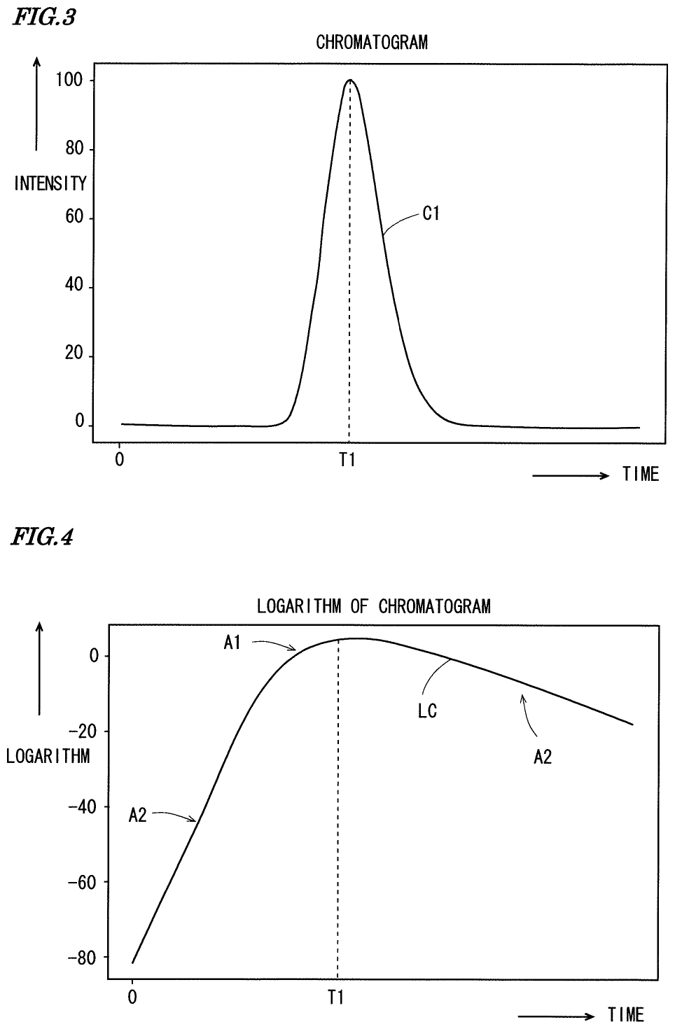

Next, a model function fitting method according to a first embodiment will be described. FIG. 3 is a diagram showing measurement data MD acquired by the acquirer 21. The measurement date MD represents a chromatogram C1 of a sample to be analyzed. In FIG. 3, the abscissa indicates time, and the ordinate indicates an intensity (detection value). As shown in the diagram, a peak of the chromatogram C1 is detected at a point T1 in time. A peak height is normalized at the intensity of 100.

FIG. 4 is a diagram showing a logarithm LC of the chromatogram C1 shown in FIG. 3. As shown in FIG. 4, the logarithm LC of the chromatogram C1 has a first portion A1 being approximatable to a quadratic function. The first portion A1 is an area including the point T1 in time. Further, the logarithm LC has second portions A1, A2 being approximatable to a linear function on both sides of the first portion A1. As such, as the model function described by a logarithmic scale, the fitter 22 uses a sequence L[t] (t represents time) in which a second order differential (second order derivative) is non-positive. That is, the characteristic that the model function described by a logarithmic scale is convex upward is used as the constraint of the model function. Thus, also in a case in which a parameter of the model function is changed, it is possible to reduce the possibility that the model function takes a shape that is unlike for a chromatogram.

Although an effective constraint can be applied to the model function in consideration of the sequence L[t] in which a second order differential is non-positive as the model function described by a logarithmic scale, the sequence L[t] has the large number of parameters. That is, in a case in which the sequence L[t] is used as the model function, because “the number of parameters of the model function”=“the number of data points of the measurement data MD,” the stability of optimization calculation is degraded. Further, in a case in which the sequence [t] is used as the model function, the model function may take a shape unlike for a chromatogram because of overfitting to the measurement data MD.

As such, preferably, the fitter 22 fits the model function to the chromatogram C1 by using a Generalized Additive Model (GAM). In the present embodiment, a smoothing spline model is used as a Generalized Additive Model. That is, the sequence L[t] in which a second order differential is non-positive is applied as the model function described by a logarithmic scale, and the Generalized Additive Model is applied to the model function by smoothing spline. In the present specification, a method of applying a Generalized Additive Model to the constraint that a second order differential is non-positive is referred to as a DGAM.

FIG. 5 shows an example in which the Generalized Additive Model using smoothing spline is applied to the chromatogram C1. In FIG. 5, fourth order splines SP1, SP2, SP3 are arranged at intervals of about one third of a peak half value width. Splines are not shown in the area farther leftward than the spline SP1 and the area farther rightward than the spline SP3. The intervals at which the splines are arranged are not particularly limited. In this example, the spline intervals are set to about one third of the peak half value width, which causes approximation accuracy to be increased empirically. Further, the spline intervals do not have to be equal among a plurality of arranged splines. In an area not including a peak, it is possible to reduce the number of parameters by increasing a spline interval. Further, in a case in which peak tailing is present, a spline interval is preferably determined using a half value width obtained in the area where tailing is not present, that is, in the area where an abrupt change is present.

In this manner, in the present embodiment, the fitter 22 fits the model function to the chromatogram utilizing the Generalized Additive Model. In the Generalized Additive Model, parameters are arranged in a chronological order. It is possible to add a restriction of a convex function while performing smoothing by applying the constraint that a second order differential of a parameter is non-positive. Further, as described above, as compared to a case in which the sequence L[t] is used as the model function, it is possible to reduce the number of parameters and reduce an amount of calculation. In a case in which a smoothing spline model is utilized, the number of parameters can be reduced to the number of peaks of splines. In a case in which a least squares method is used, the number of parameters is not a major issue. However, in a case in which Bayesian inference is performed, for regression, using a Markov chain Monte Carlo method (MCMC), a reduction in number of parameters is a great advantage in calculation.

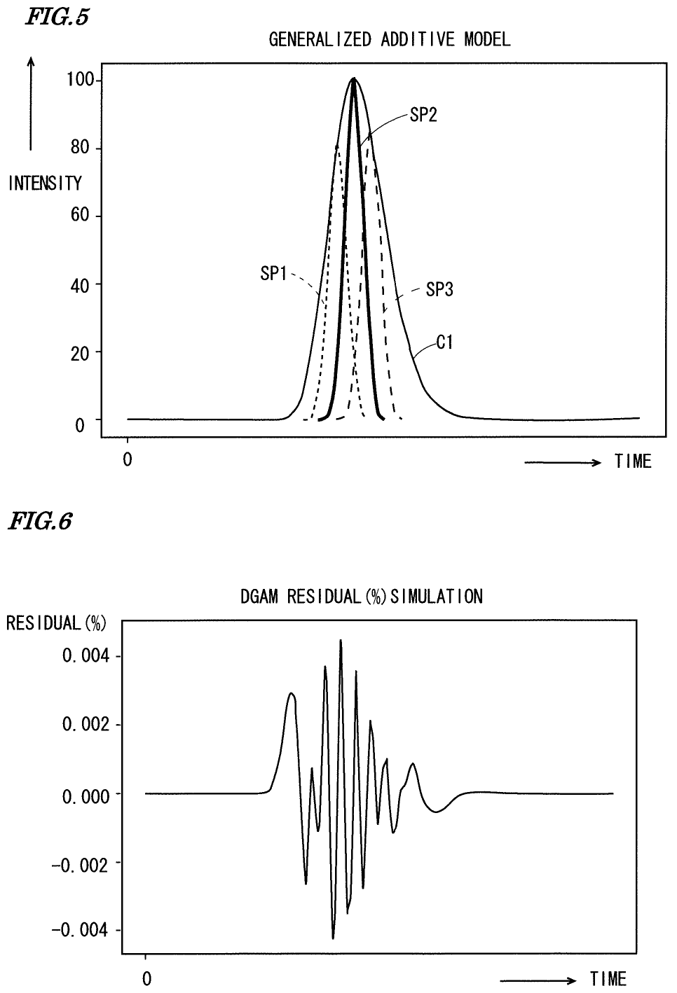

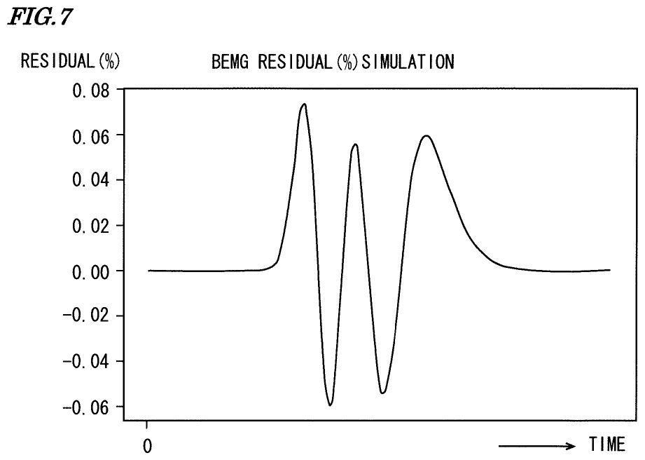

FIG. 6 is a diagram showing a result of simulation of fitting using the DGAM. FIG. 6 is a diagram showing the residual between the simulation data of a chromatogram and a model function calculated using the DGAM. FIG. 7 is a diagram showing a result of simulation of fitting using a BEMG as a comparative example. FIG. 7 is a diagram showing the residual between the simulation data, which is the same data as that of FIG. 6, and a model function calculated using the BEMG. It is found that, with the BEMG, an error of about 0.08% is present, whereas an error is suppressed to about 0.005% with the DGAM. With the DGAM, since an error amount has a trade-off relationship with a spline interval and a spline order, it is possible to realize a target error amount by adjusting the spline interval and the spline order. In this manner, with the DGAM, a model function can be approximated with the minimum number of parameters.

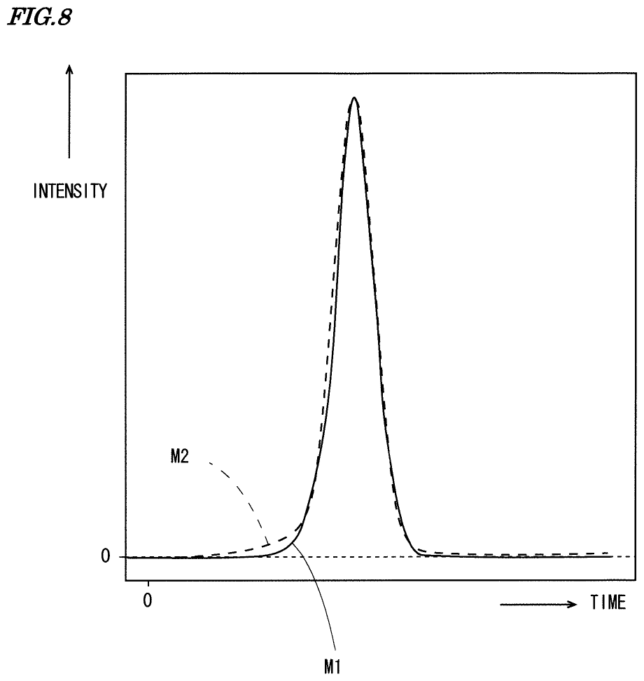

In regard to fitting of a model function, a unimodal restriction is used in a peak separation algorithm such as MCR-ALS as a restriction method of suppressing an error. The DGAM in the present embodiment can apply a strong constraint to a model function even compared with a unimodal restriction. FIG. 8 is a diagram showing the comparison of results of fitting with the DGAM and the unimodal restriction. FIG. 8 shows a model function fitted to the same measurement data MD utilizing the DGAM and the unimodal restriction. In the diagram, M1 is a model function fitted using the DGAM, and M2 is a model function fitted using the unimodal restriction. Thus, it is found that fitting accuracy of the DGAM is high even compared with the unimodal restriction.

By using the DGAM of the present embodiment for calculating an area of one or a plurality of peaks included in a chromatogram, it is possible to accurately perform a quantitative analysis and a qualitative analysis of a sample. In a case in which a model function is used for a chromatogram separation algorithm, its accuracy of approximation is important. In management of impurities of a pharmaceutical product, it is necessary to manage an impurity peak of a very minute amount (0.05%, for example) compared to a main component peak. In such application, as a matter of course, an error of a model function used for fitting is required to be smaller than 0.05%. However, a model function such as the BEMG has an error of about 0.1% as described with reference to FIG. 7. This error is also confirmed in chromatogram simulation using a Radke-Prausnitz adsorption isotherm model or the like. In contrast, with the DGAM which is the method of the present embodiment, as described with reference to FIG. 6, an error of fitting is smaller than 0.05%. Thus, it is possible to utilize the DGAM as the chromatogram separation algorithm in the pharmaceutical field where minute impurities are to be managed.

### (4) Second Embodiment

Next, a model function fitting method according to a second embodiment will be described. The formula 1 is a formula expressing a model function exp(g (x, a, b)) according to the second embodiment. In the formula 1, x is a retention time obtained when a peak position and a peak width are normalized. That is, letting a peak position be u and letting a peak width be s, (x−u)/s is input to x. Further, in the formula 1, a, b are tailing parameters.

$$[ Formula 1 ]$$

$$exp ( g ( x , a , b ) ) = exp ( - \frac{( b + a ) log ( cosh ( x ) ) + bx - ax}{2} ) \qquad ( 1 )$$

In the formula 1, as shown in FIG. 4, g(x, a, b) has the first portion A1 being approximatable to a quadratic function and the second portions A2, A2 being approximatable to a linear function on both sides of the first portion A1. That is, the logarithmic function of exp(g(x, a, b)), which is a model function, has the first portion A1 being approximatable to a quadratic function, and the second portions A2, A2 being approximatable to a linear function on both sides of the first portion A1. In this manner, the model function of the second embodiment also has a constraint that the model function described by a logarithmic scale is convex upward. The model function exp(g(x, a, b)) of the present embodiment having such a constraint is referred to as an Exponential of Modified Log Cosh (EMLC) function in the present specification.

Further, a model function exp(h(x, a, b)) that is normalized in regard to a peak position, a peak height and a peak width is expressed by the formula 2. In the formula 2, β is a beta function.

$$[ Formula 2 ]$$

$$exp ( h ( x , a , b ) ) = \qquad ( 2 )$$

$$exp ( - \frac{\begin{matrix}( b + a ) log ( cosh ( \frac{{2}^{\frac{2 ab}{b + a} - 1} β ( A , A ) x}{\sqrt{π}} - a tanh ( \frac{b - a}{b + a} ) ) ) + \\ \frac{( b - a ) {2}^{\frac{2 ab}{b + a} - 1} β ( A , A ) x}{\sqrt{π}} + ( - b - a ) log ( \frac{1}{2 \sqrt{B} \sqrt{C}} )\end{matrix}}{2} )$$

$$where \begin{matrix}A = \frac{ab}{b + a} & B = \frac{a}{b + a} & C = \frac{b}{b + a}\end{matrix}$$

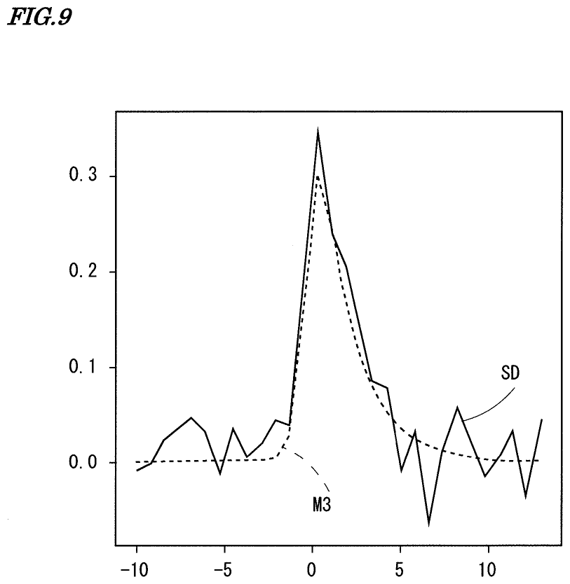

The EMLC function of the present embodiment has less collinearity of parameters, and can enhance the efficiency of Bayesian inference and optimization. FIG. 9 shows a result of estimation of an EMLC function by Bayesian inference using simulation data as measurement data MD. In FIG. 9, SD is the simulation data, and M3 is a model function (EMLC function) estimated by Bayesian inference. In regard to this simulation, Bayesian inference is performed with a peak height H, as a parameter, added in addition to the peak position u, the peak width s and the tailing parameters a, b, described above.

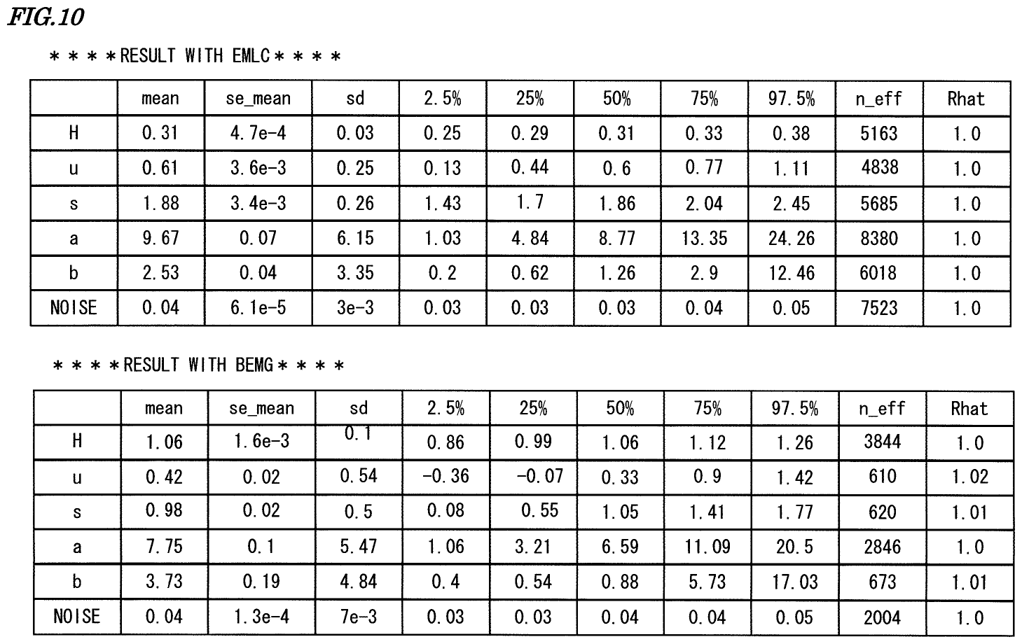

The simulation shown in FIG. 9 was performed using Bayesian inference software stan. Noise of a normal distribution centered at 0 is added to the simulation data. Bayesian inference was performed with 2000 iterations and 12 chains. FIG. 10 shows a result of simulation using Bayesian inference that is performed using stan. As a comparative example, a result of Bayesian inference performed on the same simulation data SD using the BEMG as a model function is also shown. As shown in FIG. 10, with the EMLC, it is found that a value of Rhat (convergence determination index) is close to 1.0, and that the estimation accuracy is higher than that with the BEMG. Further, it is found that, also in regard to an index n_eff (the number of valid samples) indicating that sampling is efficiently performed, a value is larger with the EMLC than with the BEMG, and that estimation accuracy is high. Further, se-mean is a standard error, and its value is smaller with the EMLC than with the BEMG. In this manner, it is found that using the EMLC is advantageous in calculation in which a derivative of a function is utilized, such as Bayesian inference using MCMC sampling.

FIG. 11 is a diagram showing the comparison of results of fitting where the EMLC is used as a model function, the EMG is used as the model function and the BEMG is used as a model function, in regard to actually measured measurement data MD. The measurement data MD is a chromatogram relating a standard product of a primary metabolite. FIG. 11 shows a histogram representing the mean square error between area quantification of a standard product (the maximum peak height is 1) and area quantification of each model function. As shown in FIG. 11, the histogram of the EMLC shows a high value in the area where the square error is close to 0. In this manner, it is found that fitting can be performed more accurately with the EMLC than with the EMG or the BEMG.

How to obtain the EMLC function expressed by the formula 1 and the normalized EMLC function expressed by the formula 2 will be described. In f(x, a, b) expressed by the formula 3, a constant is added to the formula obtained when a sigmoid function is multiplied by a constant.

$$[ Formula 3 ]$$

$$f ( x , a , b ) = - \frac{( b + a ) tanh ( x ) + b - a}{2} \qquad ( 3 )$$

The result of integration of f(x, a, b) expressed by the formula 3 is g(x, a, b) expressed by the formula 4. That is, the formula 4 expresses g(x, a, b) in the formula 1. That is, g(x, a, b) is the logarithmic function of the EMLC function and has an upwardly convex shape.

$$[ Formula 4 ]$$

$$g ( x , a , b ) = - \frac{( b + a ) log ( cosh ( x ) ) + bx - ax}{2} \qquad ( 4 )$$

It is more preferable that a tailing parameter or a leading parameter does not have a significant influence on a peak feature such as a peak position, a peak height, a peak area or a peak width. Such conditions reduce collinearity in fitting to a chromatogram having a standard tailing shape or a standard leading shape. Therefore, since a peak position and a peak height of exp(g(x, a, b)) are analytically obtained, it is desirable to use a function gg(x, a, b) with the normalized peak position and the normalized peak height. The formula 5 expresses the function gg(x, a, b) obtained when g(x, a, b) is normalized. Instead of a peak position or a peak height, another peak feature such as the center of gravity may be used for normalization.

$$[ Formula 5 ]$$

$$gg ( x , a , b ) = - \frac{\begin{matrix}( b + a ) log ( cosh ( x - a tanh ( \frac{b - a}{b + a} ) ) ) + \\ ( b - a ) x + ( - b - a ) log ( \frac{1}{2 \sqrt{\frac{a}{b + a}} \sqrt{\frac{b}{b + a}}} )\end{matrix}}{2} \qquad ( 5 )$$

It is empirically required that an area Ns(a, b) of the function gg(x, a, b) is approximated by the formula (6).

$$[ Formula 6 ]$$

$$Ns ( a , b ) = {2}^{\frac{2 ab}{b + a} - 1} β ( \frac{ab}{b + a} , \frac{ab}{b + a} ) = exp ( log ( 2 ) * ( \frac{2 ab}{b + a} - 1 ) + log β ( \frac{ab}{b + a} , \frac{ab}{b + a} ) ) \qquad ( 6 )$$

In the formula 5, correction is made by multiplication of x by Ns(a, b). Thus, a peak width is corrected so that an area is constant for normalization of a peak shape. The function after normalization is expressed by the formula 7. Instead of an area, correction may be made using a formula that is empirically obtained in regard to a half value width or a formula obtained by machine learning. The formula 7 expresses h(x, a, b) in the formula 2. More preferably, in order to prevent a loss of significance at the time of floating-point arithmetic, log β obtained when a beta function p is modified can be used as shown in the formula 6.

$$[ Formula 7 ]$$

$$h ( x , a , b ) = - \frac{\begin{matrix}( b + a ) log ( cosh ( \frac{{2}^{\frac{2 ab}{b + a} - 1} β ( A , A ) x}{\sqrt{π}} - a tanh ( \frac{b - a}{b + a} ) ) ) + \\ \frac{( b - a ) {2}^{\frac{2 ab}{b + a} - 1} β ( A , A ) x}{\sqrt{π}} + ( - b - a ) log ( \frac{1}{2 \sqrt{B} \sqrt{C}} )\end{matrix}}{2} \\ where \begin{matrix}A = \frac{ab}{b + a} & B = \frac{a}{b + a} & C = \frac{b}{b + a}\end{matrix} \qquad ( 7 )$$

In a case in which a model function such as the EMG or the BEMG is used for function optimization or Bayesian inference, a peak position or a peak width varies depending on the magnitude of a tailing parameter, for example. With these model functions, since the relationship between parameters is strong, there is a problem that a function cannot be fitted to a target shape unless a plurality of parameters are largely changed, although the change amount of a square error is small. In particular, in a case in which the strength of the relationship between parameters is different depending on the state of the parameters, it is difficult to set a momentum term in optimization based on a gradient method, etc. It is empirically known that, when a method using a derivative of a model function such as function optimization or Bayesian inference is used with respect to the BEMG function in a case in which two peaks of a chromatogram are adjacent to each other, or a case in which a noise is large, etc., the BEMG function is likely to fall into a local solution. In contrast, the EMLC function in the present embodiment is convenient for function optimization or Bayesian inference because the collinearity between parameters is suppressed.

Further, with a model function such as the EMG or the BEMG, parameters are not expressed in a manner that is easy for a human to interpret, such as a peak position or a half value width. Therefore, there is a problem that it is difficult for a user to understand a model function. In contrast, the EMLC function of the present embodiment is modified by normalization into a format that is easy for the user to understand. Further, a model function such as the EMG or the BEMG includes multiplication of exp and erfc. In the calculation of a peak tail portion, a value close to 0 and a value close to ∞ are multiplied, and a minute value is obtained as a result. Therefore, since degradation of accuracy such as a loss of significance occurs, it is necessary to prepare a function separately for a tail portion, and calculation is difficult. In contrast, by normalization as described above, the EMLC function of the present embodiment can prevent a loss of significance caused by calculation.

### (5) Third Embodiment

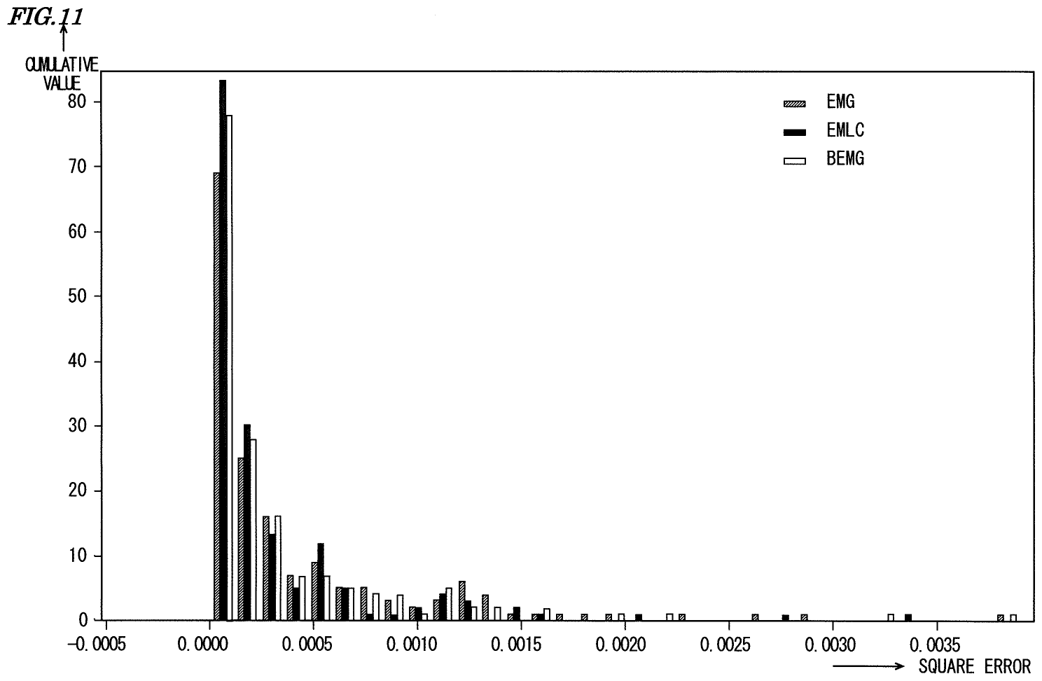

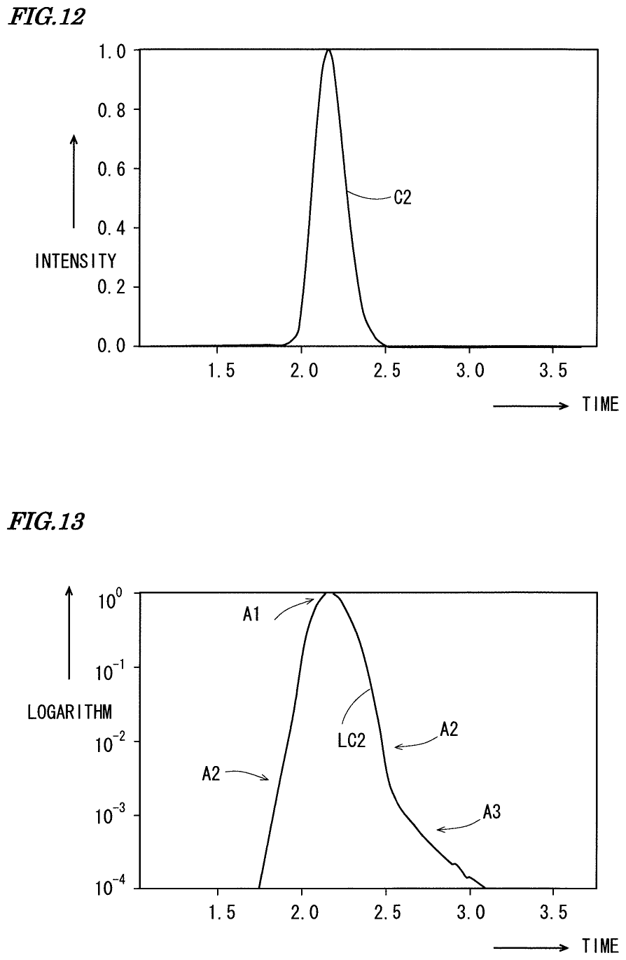

Next, a model function fitting method according to a third embodiment will be described. FIG. 12 shows a chromatograph C2 of a sample to be analyzed in the third embodiment and a fourth embodiment. In FIG. 12, the abscissa indicates time, and the ordinate indicates an intensity (detection value). As shown in the diagram, a peak height is normalized at the intensity of 1.0. Tailing is present in the chromatogram C2. FIG. 13 is a diagram showing a logarithm LC2 of the chromatogram C2 shown in FIG. 12. As shown in FIG. 13, the logarithm LC2 of the chromatogram C2 has a first portion A1 being approximatable to a quadratic function, and second portions A2, A2 being approximatable to a linear function on both sides of the first portion A1. However, the logarithm LC2 has a third portion A3, which is an area where a second order derivative is positive, in the area outside of the second portion A2. The third portion A3 is present due to tailing in the chromatogram C2. In this manner, although the model function of the third embodiment has a constraint that the model function described by a logarithmic scale is convex upward in many portions, a deviation from the constraint is allowed in some areas.

It is difficult to perform accurate fitting for such a chromatogram C2 using the method described in the first and second embodiments. Therefore, the fitter 22 fits a function, that is obtained when a conversion function smoother than an exponential function is applied to a function having the non-positive second order differential (hereinafter referred to as an original function), as a model function, to the chromatogram C2.

### (5-1) Conversion Function Using Gamma Correction Function

The fitter 22 uses a composite function of an exponential function and a gamma correction function, for example, as a conversion function to be applied to an original function. Letting an original function be B(t), letting a gamma correction function be G, and letting an exponential function be exp, the conversion function is expressed by exp(G(*)). The formula 8 is an example of the gamma correction function used for the conversion function.

$$[ Formula 8 ]$$

$$G ( x ) = - ( {( q - rx )}^{p} - q ) \qquad ( 8 )$$

In the formula (8), a parameter q is a constant that is equal to or larger than 0. The larger the value of the parameter q is, the smaller a chromatogram intensity is in a region in which effect of gamma correction can be obtained. The parameter p is usually a value equal to or smaller than 1, and the range of positive value allowing a deviation is set. A parameter r is a parameter for adjusting a peak width.

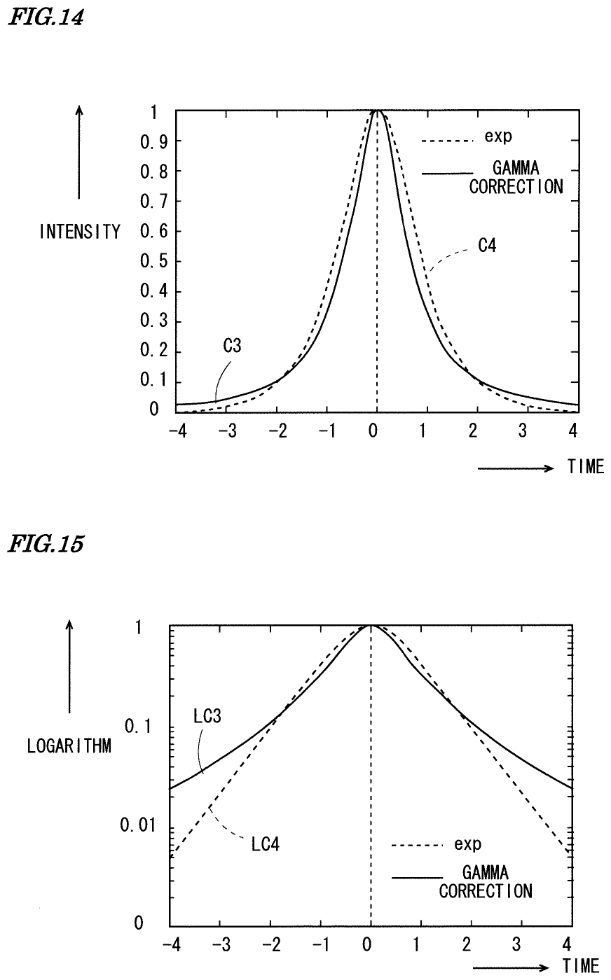

In FIG. 14, the solid line indicates a chromatogram C3 obtained when the conversion function exp(G(*)) is applied to the original function B(t). In the conversion function exp(G(*)), the gamma correction function G in which p=0.5, q=1 and r=4 and which is expressed by the formula 8 is used. In FIG. 14, the dotted line indicates a chromatogram C4 obtained when the conversion function is not applied but an exponential function is applied to the original function. The same original function is used for the chromatograms C3, C4. That is, the chromatogram C3 is represented by exp(G(B(t))), and the chromatogram C4 is represented by exp(B(t)). In FIG. 15, the solid line indicates a logarithm LC3 of the chromatogram C3, and the dotted line indicates a logarithm LC4 of the chromatogram C4. It is found that the logarithm LC4 is under the constraint that a second order derivative is non-positive, whereas the logarithm LC3 deviates from the constraint that a second order derivative is non-positive in an area away from a peak. In this manner, the model function of the third embodiment is allowed to deviate from the constraint that a second order derivative is non-positive in some areas of the logarithmic function. This enables highly accurate fitting even with respect to a chromatogram with leading or tailing.

### (5-2) Conversion Function Using Polynomial

As another example of a conversion function, a polynomial can be used. The formula 9 is an example in which a polynomial is used as a conversion function Q. The value of an original function is input to x in the formula 9. For example, in a case in which the original function B(t)=−t\hat{ }2, a chromatogram to which a conversion function is applied is obtained when −t\hat{ }2 is input to x in the formula 9.

$$[ Formula 9 ]$$

$$Q ( x ) = \frac{- 1}{1 - x + {x}^{2}} \qquad ( 9 )$$

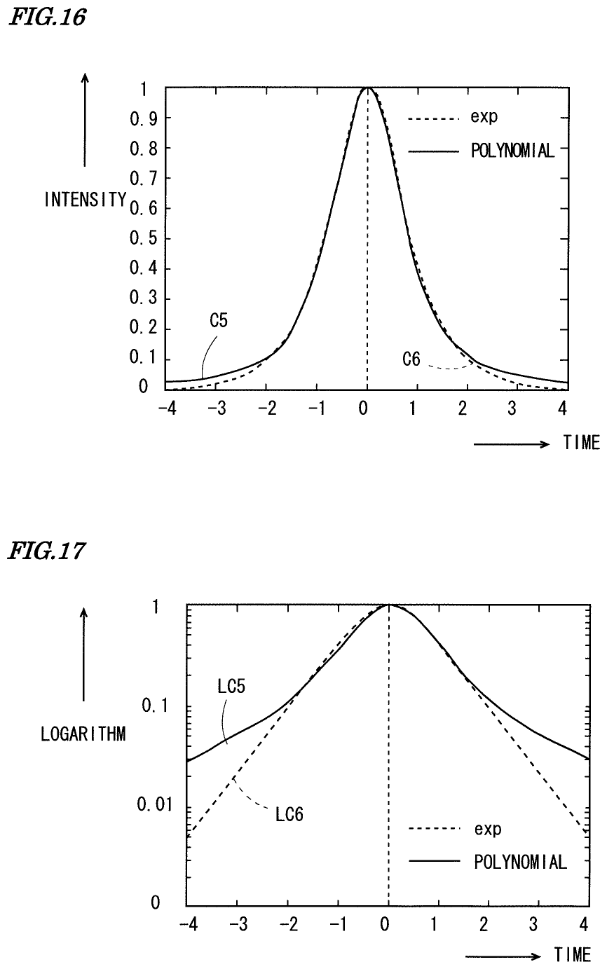

In FIG. 16, the solid line indicates a chromatogram C5 obtained when the conversion function expressed by the formula 9 is applied to the original function. In FIG. 16, the dotted line indicates a chromatogram C6 obtained when the conversion function is not applied but an exponential function is applied to the original function. The same original function is used for the chromatograms C5, C6. In FIG. 17, the solid line indicates a logarithm LC5 of the chromatogram C5, and the dotted line indicates a logarithm LC6 of the chromatogram C6. It is found that the logarithm LC6 is under the constraint that a second order derivative is non-positive, whereas the logarithm LC5 deviates from the constraint that a second order derivative is non-positive in an area away from a peak.

A general formula as shown in the formula 10, for example, can be used for a conversion function Q(x) using a polynomial. That is, the conversion function Q(x) is expressed by a function including an n-th order polynomial in a denominator.

$$[ Formula 10 ]$$

$$Q ( x ) = \frac{1}{1 + {\sum }_{i} {s}_{i} * {( - x )}^{i}} \qquad ( 10 )$$

### (5-3) Conversion Function Using Cosh Function

As another example of a conversion function, a cosh function can also be used. The formula 11 is an example in which a cosh function is used as a conversion function Q. In the formula 11, u is a parameter for adjusting a peak width. In this manner, the conversion function Q(x) is expressed by a function including a cosh function in a denominator.

$$[ Formula 11 ]$$

$$Q ( x ) = \frac{1}{cosh ( {u ( - x )}^{0.5} )} \qquad ( 11 )$$

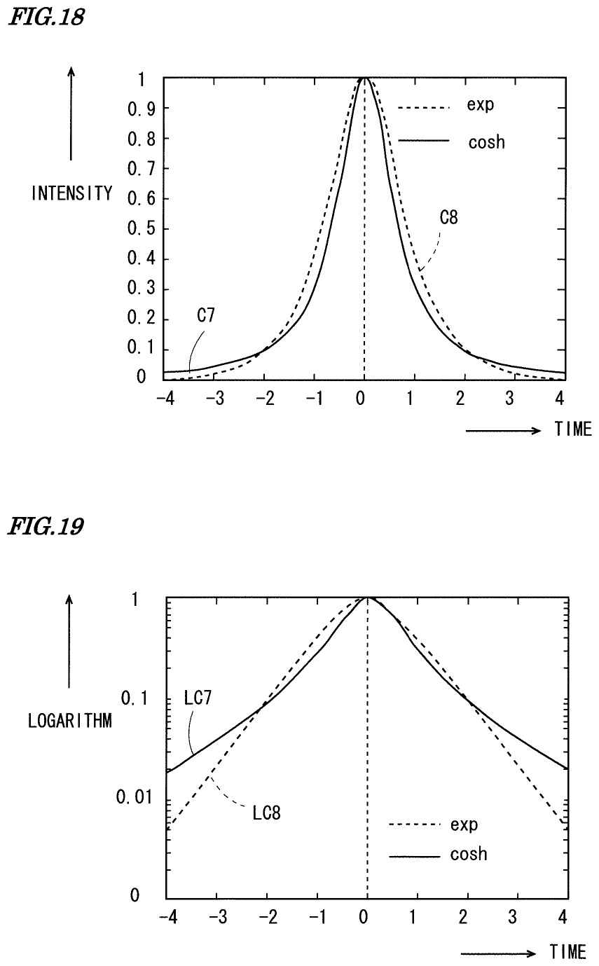

In FIG. 18, the solid line indicates a chromatogram C7 obtained when the conversion function expressed by the formula 11 is applied to an original function. The chromatogram shown in FIG. 18 is obtained when u=1.5 in the formula 11. In FIG. 18, the dotted line indicates a chromatogram C8 obtained when a conversion function is not applied but an exponential function is applied to an original function. The same original function is used for the chromatograms C7, C8. In FIG. 19, the solid line indicates a logarithm LC7 of the chromatogram C7, and the dotted line indicates a logarithm LC8 of the chromatogram C8. It is found that the logarithm LC8 is under the constraint that a second order derivative is non-positive, whereas the logarithm LC7 deviates from the constraint that a second order derivative is non-positive in an area away from a peak.

As described above, a gamma correction function, a polynomial or a cosh function is utilized as an example of a conversion function. These functions are examples, and a monotonic function having a gentler slope than that of an exponential function can be used as a conversion function.

### (6) Fourth Embodiment

Next, a model function fitting method according to a fourth embodiment will be described. Similarly to the third embodiment, although the model function according to the fourth embodiment has a constraint that the model function described by a logarithmic scale is convex upward in many portions, a deviation from the constraint is allowed in some areas. In the fourth embodiment, the deviation from the constraint is allowed by distortion of time. The fitter 22 fits a model function to a chromatogram by applying a GAM model to a time distortion function.

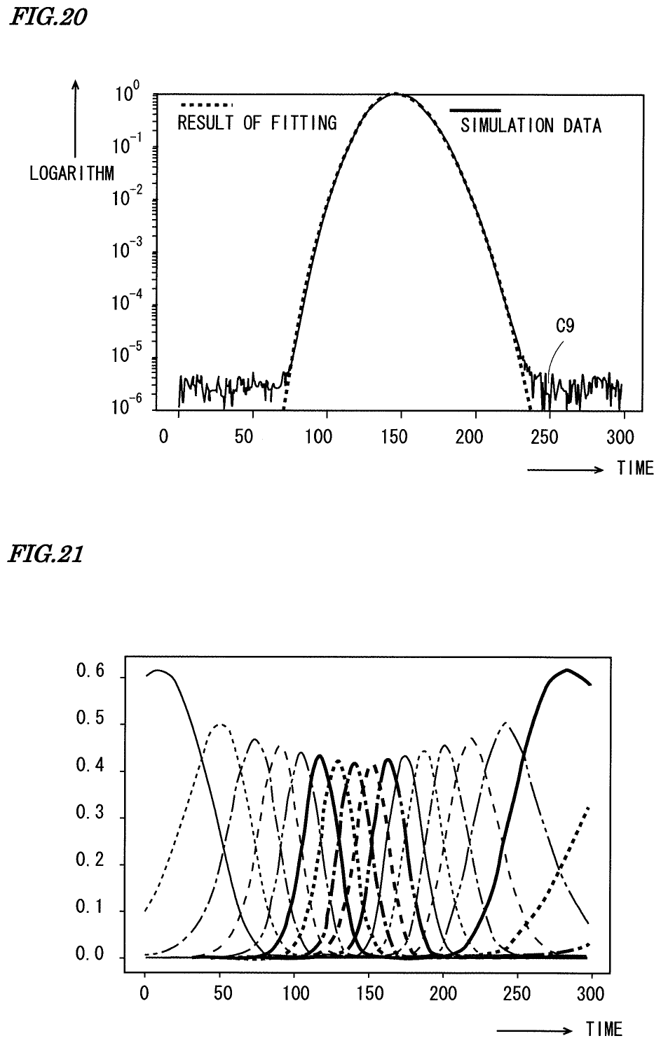

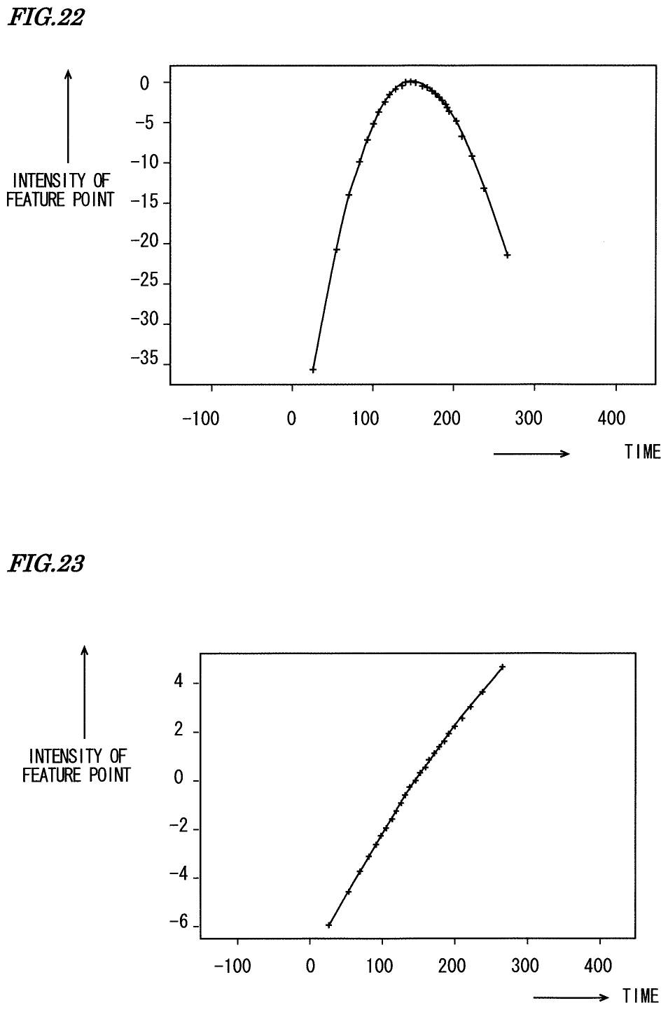

A function that distorts time t is expressed by m(t). For example, when time distortion by m(t) is applied to a chromatogram expressed by exp(−t\hat{ }2), the chromatogram is expressed by exp(−m(t)\hat{ }2). For example, a logarithmic chromatogram LC9 as shown in FIG. 20 is considered. In FIG. 20, the solid line represents simulation data of the logarithmic chromatogram LC9. In a case in which a spline as shown in FIG. 21 is fitted to the logarithmic chromatogram LC9 by the GAM, the intensity of each feature point is as shown in FIG. 22. In contrast, in a case in which a spline is fitted to the time distortion function m(t), the intensity value of each feature point is as shown in FIG. 23. Because having a shape close to a straight line, the time distortion function m(t) is compatible with the GAM. As shown in FIG. 23, the time distortion function m(t) has a gentle slope in an area away from a peak, as compared with m(t)=t. In the example of FIG. 23, the time in a tailing portion at the right of the peak is distorted. Conversely, in a case in which the time in a leading portion at the left of the peak is distorted, the time distortion function m(t) is distorted to have a gentle slope in the time corresponding to the leading portion. A result of fitting in which the GAM is applied to the time distortion function m(t) is indicated by the dotted line in FIG. 20.

Here, the constraint that a second order derivative is non-positive may be applied to a logarithmic chromatogram to which the time distortion function m(t) is applied, or may be applied to the time distortion function m(t). It is considered that the time distortion function m(t) is applied to a chromatogram expressed by exp(−t\hat{ }2), for example. In this case, a logarithmic chromatogram is −m(t)\hat{ }2. The constraint that a second order derivative of the logarithmic chromatogram −m(t)\hat{ }2 is non-positive is expressed by the formula 12.

$$[ Formula 12 ]$$

$$2 m ( x ) {m}^{″} ( x ) + 2 {{m}^{′} ( x )}^{2} \leq 0 \qquad ( 12 )$$

Although the constraint expressed by the formula 12 may be implemented as an optimization algorithm, it increases an amount of calculation. As such, in order to reduce the amount of calculation, it is considered to apply a constraint to the time distortion function m(t). In regard to the time distortion function m(t), the farther an area is from the center of a peak, the smaller the slope, that is, the smaller the value of a first order derivative of m(t). By using this constraint, it is possible to apply the constraint equivalent to a unimodal restriction. This constraint is expressed by the formula 13 with successively arranged feature points as tn.

$$[ Formula 13 ]$$

$$0 \leq \frac{f ( {t}_{3} ) - f ( {t}_{2} )}{f ( {t}_{2} ) - f ( {t}_{1} )} \leq 1 \qquad ( 13 )$$

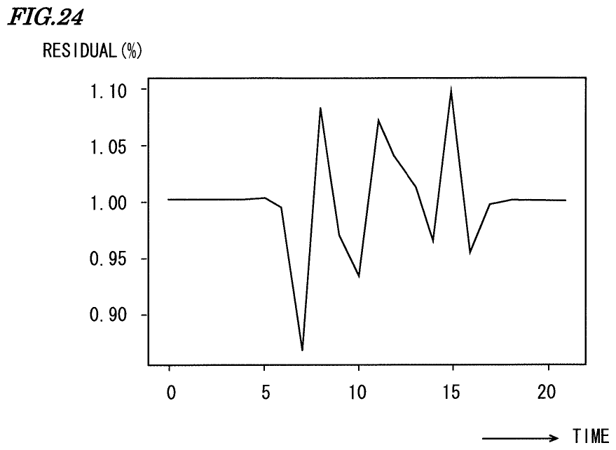

Although the lower limit is 0 for the formula 13, the lower limit of a model function of an actual chromatogram or a function using the GAM model satisfying a condition that a second order derivative is non-positive is not 0, and is empirically within a certain range of values. Therefore, the lower limit may be set to an empirically obtained value that is larger than 0 and smaller than 1. Further, in a case in which the GAM model is used, only a function defined by a spline can be expressed. Therefore, a minute systematic error remains. Therefore, even in a case in which fitting is simply performed on a waveform without tailing, vibration of coefficient may occur as shown in FIG. 24. In order to allow such vibration of coefficient, the upper limit may be allowed to exceed 1 in the formula 13. It is desirable that this allowable range is empirically obtained by a systematic error of a model function and a peak width (the number of feature points and a spline dimension) using the GAM. Letting the lower limit and the upper limit, which are empirically obtained be Ca and Cb, the constraint of the formula 13 is expressed by the formula 14.

$$[ Formula 14 ]$$

$${C}_{a} \leq \frac{f ( {t}_{3} ) - f ( {t}_{2} )}{f ( {t}_{2} ) - f ( {t}_{1} )} \leq {C}_{b} \qquad ( 14 )$$

In this manner, although the model function of the fourth embodiment has the constraint that f a model function described by a logarithmic scale is convex upward in many portions, a deviation from the constraint is allowed in some areas by distortion of time of an original function. This enables fitting of a model function with higher accuracy.

### (7) Flow of Process of Program

FIG. 25 is a flowchart showing a model function fitting method according to the first and second embodiments executed by the program P1. That is, FIG. 12 is a flowchart of a process executed by the CPU 11. First, in the step S1, the acquirer 21 acquires measurement data MD. The measurement data MD is a chromatogram acquired by a liquid chromatograph, for example.

Next, in the step S2, the fitter 22 fits a model function to a chromatogram, while applying a constraint to the model function that the model function described by a logarithmic scale has a first portion being approximatable to a quadratic function and second portions that are located at both sides of the first portion and being approximatable to a linear function. In the step S2, in the first embodiment, a model function to which a constraint that a second order differential is non-positive is applied is used. In the step S2, in the second embodiment, a function obtained by integration of a function obtained by addition by constant of a function obtained by constant multiplication of a sigmoid function are used as the model function described by a logarithmic scale.

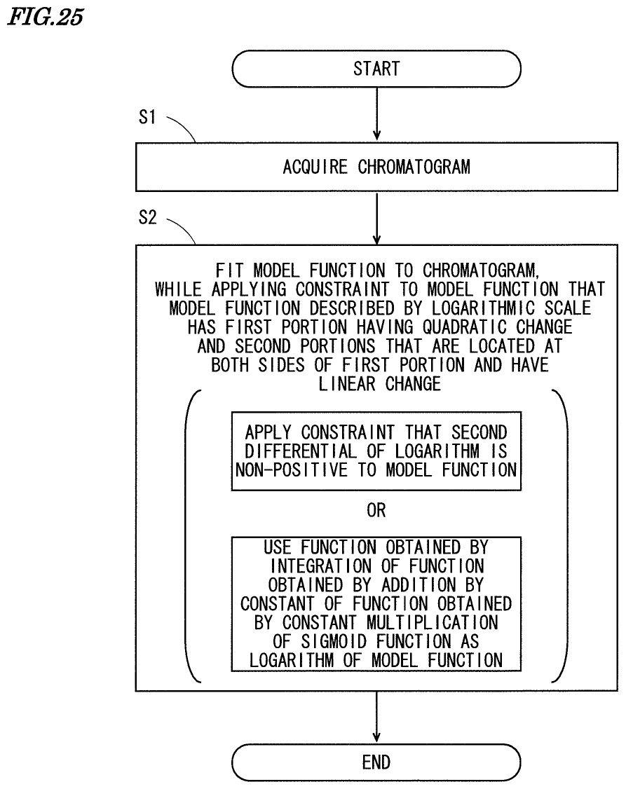

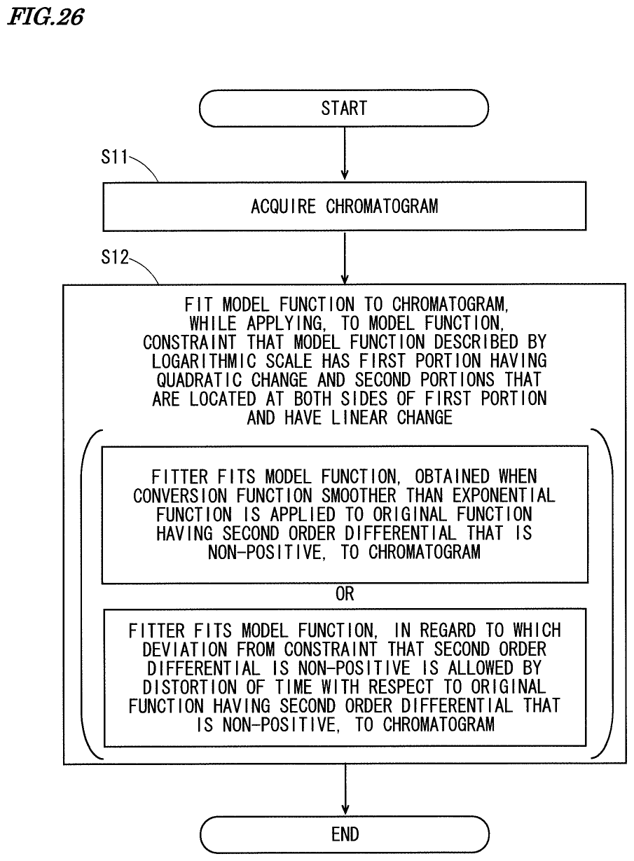

FIG. 26 is a flowchart showing a model function fitting method according to the third and fourth embodiments executed by the program P1. That is, FIG. 26 is a flowchart of a process executed by the CPU 11. First, in the step S11, the acquirer 21 acquires measurement data MD. The measurement data MD is a chromatogram acquired by a liquid chromatograph, for example.

Next, in the step S12, the fitter 22 fits a model function to a chromatogram, while applying a constraint to the model function that the model function described by a logarithmic scale has a first portion being approximatable to a quadratic function and second portions that are located at both sides of the first portion and being approximatable to a linear function. In the step S12, in the third embodiment, the fitter 22 fits a model function, obtained when a conversion function smoother than an exponential function is applied to an original function having the non-positive second order differential, to a chromatogram. In the step S2, in the fourth embodiment, the fitter 22 fits a model function, being allowed to deviate from a constraint that a second order differential is non-positive by distortion of time with respect to an original function having the non-positive second order differential, to a chromatogram.

### (8) Modified Example

In the first embodiment, a smoothing spline model is utilized as a Generalized Additive Model. As a modified example of the first embodiment, a Bezier function, a Gaussian function or the like can also be utilized instead of a spline.

In the first embodiment, the method of applying a Generalized Additive Model (DGAM) to a constraint that a second order differential is non-positive is used. As the modified example, the EMLC function in the second embodiment may be used as an initial value when the DGAM is used. Although having a relatively large number of parameters, the DGAM can apply an effective constraint in an initial state by using the EMLC function as an initial value.

In the third embodiment, as a conversion function, a gamma correction function is used, a polynomial is used or a cosh function is used, byway of example. However, a sum, a product or a composite function of these functions may be used as a conversion function. In the third and fourth embodiments, the method of allowing a partial deviation from the constraint that a second order derivative of a logarithmic chromatogram is non-positive is described. As another method, this constraint may be relaxed by a direct and empirical method. For example, a parameter for allowing a deviation may be set empirically by a user, or the sum of positive values or the exponentiation of the positive values may be set as a penalty term for solving an optimization problem.

### (9) Aspects

It will be appreciated by those skilled in the art that the exemplary embodiments described above are illustrative of the following aspects.

### Item 1

A model function fitting device according to one aspect includes an acquirer that acquires a chromatogram, and a fitter that fits a model function to the chromatogram, while applying, to the model function, a constraint that the model function described by a logarithmic scale has a first portion being approximatable to a quadratic function and second portions being located at both sides of the first portion and being approximatable to a linear function.

It is possible to perform fitting with high accuracy.

### Item 2

The model function fitting device according to item 1, wherein the fitter may apply, to the model function, a constraint that a second order differential of the logarithmic function is non-positive.

Even in a case in which the model function has a large number of parameters, it is possible to apply an effective constraint to the model function.

### Item 3

The model function fitting device according to item 2, wherein the fitter may fit the model function to the chromatogram by using a Generalized Additive Model.

It is possible to reduce the number of parameters of the model function and enhance the stability of optimization calculation.

### Item 4

The model function fitting device according to item 2 or 3, may be used for calculation of an area of one peak or a plurality of peaks.

It is possible to perform a quantitative analysis and a qualitative analysis on measurement data with high accuracy.

### Item 5

The model function fitting device according to item 2 or 3, wherein as an initial value of the model function, a function may be used, the function being obtained by integration of a function obtained by addition by constant of a function obtained by constant multiplication of a sigmoid function as the model function described by a logarithmic scale.

Even in a case in which the model function has a large number of parameters, it is possible to apply an effective constraint to the initial value of the model function.

### Item 6

The model function fitting device according to item 1, wherein the fitter may use a function, the function being obtained by integration of a function obtained by addition by constant of a function obtained by constant multiplication of a sigmoid function as the model function described by a logarithmic scale.

It is possible to apply an effective constraint for fitting a model function to a chromatogram.

### Item 7

The model function fitting device according to item 6, wherein the model function may be a function with a normalized peak height and a normalized peak position.

The format of the model function is easy for a user to understand, and it is easy for the user to handle the model function.

### Item 8

The model function fitting device according to item 7, wherein the model function may be a function that corrects a peak width using a formula including a beta function and an exponential function.

The format of the model function is easy for a user to understand, and it is easy for the user to handle the model function.

### Item 9

The model function fitting device (1) according to item 1, wherein the fitter (22) may fit the model function to the chromatogram (C2), the model function being obtained when a conversion function having a gentler slope than that of an exponential function is applied to an original function having a second order differential that is non-positive.

It is possible to perform fitting with high accuracy by partially allowing a deviation from a constraint that a second order derivative of a logarithmic chromatogram is non-positive.

### Item 10

The model function fitting device (1) according to item 9, wherein the conversion function may include a composite function of a gamma correction function and an exponential function.

With the gamma correction function, it is possible to allow a deviation from a constraint that a second order derivative is non-positive.

### Item 11

The model function fitting device (1) according to item 9, wherein the conversion function may include a function having an n-th order polynomial in a denominator.

With the conversion function including a polynomial, it is possible to allow a deviation from a constraint that a second order derivative is non-positive.

### Item 12

The model function fitting device (1) according to item 9, wherein the conversion function may include a function having a cosh function in a denominator.

With the conversion function including a cash function. It is possible to allow a deviation from a constraint that a second order derivative is non-positive.

### Item 13

The model function fitting device (1) according to item 1, wherein the fitter (22) may fit the model function to the chromatogram, the model function being allowed to deviate from a constraint that a second order differential is non-positive by distortion of time with respect to an original function having a non-positive second order differential.

It is possible to perform fitting with high accuracy by partially allowing a deviation from a constraint that a second order derivative of a logarithmic chromatogram is non-positive.

### Item 14

A model function fitting method according to another aspect includes the steps of acquiring a chromatogram, and fitting a model function to the chromatogram, while applying, to the model function, a constraint that the model function described by a logarithmic scale has a first portion being approximatable to a quadratic function and second portions being located at both sides of the first portion and being approximatable to a linear function.

It is possible to perform fitting with high accuracy.

### Item 15

The model function fitting method according to item 14, wherein the step of fitting may include applying, to the model function, a constraint that a second order differential of the logarithmic function is non-positive.

Even in a case in which the model function has a large number of parameters, it is possible to apply an effective constraint to the model function.

### Item 16

The model function fitting method according to item 14, wherein the step of fitting may include using a function, the function being obtained by integration of a function obtained by addition by constant of a function obtained by constant multiplication of a sigmoid function as the model function described by a logarithmic scale.

It is possible to apply an effective constraint for fitting a model function to a chromatogram.

### Item 17

The model function fitting method according to item 14, wherein the step of fitting (S12) may include fitting the model function to the chromatogram (C2), the model function being obtained when a conversion function having a gentler slope than that of an exponential function is applied to an original function having a non-positive second order differential.

It is possible to perform fitting with high accuracy by partially allowing a deviation from a constraint that a second order derivative of a logarithmic chromatogram is non-positive.

### Item 18

The model function fitting method according to item 14, wherein the step of fitting (S12) includes fitting the model function to the chromatogram (C2), the model function being allowed to deviate from a constraint that a second order differential is non-positive by distortion of time with respect to an original function having a non-positive second order differential.

It is possible to perform fitting with high accuracy by partially allowing a deviation from a constraint that a second order derivative of a logarithmic chromatogram is non-positive.

1. A model function fitting device comprising:
an acquirer that acquires a chromatogram; and
a fitter that fits a model function to the chromatogram, while applying, to the model function, a constraint that the model function described by a logarithmic scale has a first portion being approximatable to a quadratic function and second portions being located at both sides of the first portion and being approximatable to a linear function.

2. The model function fitting device according to claim 1, wherein
the fitter applies, to the model function, a constraint that a second order differential of the logarithmic function is non-positive.

3. The model function fitting device according to claim 1, wherein
the fitter fits the model function to the chromatogram by using a Generalized Additive Model.

4. The model function fitting device according to claim 2, being used for calculation of an area of one peak or a plurality of peaks.

5. The model function fitting device according to claim 2, wherein
as an initial value of the model function, a function is used, the function being obtained by integration of a function obtained by addition by constant of a function obtained by constant multiplication of a sigmoid function as the model function described by a logarithmic scale.

6. The model function fitting device according to claim 1, wherein
the fitter uses a function, the function being obtained by integration of a function obtained by addition by constant of a function obtained by constant multiplication of a sigmoid function as the model function described by a logarithmic scale.

7. The model function fitting device according to claim 6, wherein
the model function is a function with a normalized peak height and a normalized peak position.

8. The model function fitting device according to claim 7, wherein
the model function is a function that corrects a peak width using a formula including a beta function and an exponential function.

9. The model function fitting device according to claim 1, wherein
the fitter fits the model function to the chromatogram, the model function being obtained when a conversion function having a gentler slope than that of an exponential function is applied to an original function having a second order differential that is non-positive.

10. The model function fitting device according to claim 9, wherein
the conversion function includes a composite function of a gamma correction function and an exponential function.

11. The model function fitting device according to claim 9, wherein
the conversion function includes a function having an n-th order polynomial in a denominator.

12. The model function fitting device according to claim 9, wherein
the conversion function includes a function having a cosh function in a denominator.

13. The model function fitting device according to claim 1, wherein
the fitter fits the model function to the chromatogram, the model function being allowed to deviate from a constraint that a second order differential is non-positive by distortion of time with respect to an original function having a non-positive second order differential.

14. A model function fitting method including the steps of:
acquiring a chromatogram; and
fitting a model function to the chromatogram, while applying, to the model function, a constraint that the model function described by a logarithmic scale has a first portion being approximatable to a quadratic function and second portions being located at both sides of the first portion and being approximatable to a linear function.

15. The model function fitting method according to claim 14, wherein
the step of fitting includes applying, to the model function, a constraint that a second order differential of the logarithmic function is non-positive.

16. The model function fitting method according to claim 14, wherein
the step of fitting includes using a function, the function being obtained by integration of a function obtained by addition by constant of a function obtained by constant multiplication of a sigmoid function as the model function described by a logarithmic scale.

17. The model function fitting method according to claim 14, wherein
the step of fitting includes fitting the model function to the chromatogram, the model function being obtained when a conversion function having a gentler slope than that of an exponential function is applied to an original function having a non-positive second order differential.

18. The model function fitting method according to claim 14, wherein
the step of fitting includes fitting the model function to the chromatogram, the model function being allowed to deviate from a constraint that a second order differential is non-positive by distortion of time with respect to an original function having a non-positive second order differential.
